(19) United States
(12) Patent Application Publication
(10) Pub. No.: US 2012/0292241 A1
(43) Pub. Date: Nov. 22, 2012

(54) PLANT FOR TREATMENT OF BIOLOGICAL SLUDGES WITH RECOVERY OF RAW MATERIALS AND ENERGY

(75) Inventors: Giorgio Bertanza, Puegnago (IT); Maria Cristina Collivignarelli, Mortara (IT); Pier Francesco Ravasio, Terno D'isola (BG) (IT)

(73) Assignee: D.T.A. SRL, Bergamo (IT)

(21) Appl. No.: 13/576,497

(22) PCT Filed: Jan. 31, 2011
(86) PCT No.: PCT/IB2011/000156

§ 371 Date: Aug. 1, 2012

(30) Foreign Application Priority Data
Feb. 5, 2010 (IT) CR2010A000004

(51) Int. Cl. C02F 3/12

(52) U.S. Cl. 210/182; 210/295; 210/188

(57) ABSTRACT

A plant for the treatment of biological sludges with recovery of secondary raw materials and energy including, in a system architecture, a feed section (1) of biological sludges and a feed section (2) of primary and secondary raw materials required for operation of the plant, characterized in that it includes a section (3) for the treatment of biological sludges wherein, through a reactor (303), a process of alkaline protein lysis is performed at medium-low temperature, through dosage of a calcium or sodium hydroxide, obtaining a suspension including a protein broth and a suspended body composed of the calcium or sodium hydroxide, of the non-solubilized organic fraction and of the particulate of the hydroxides of the polluting metals contained in the sludges and wherein, through a forced filtration device (304) of the suspension, separation of the liquid protein lysate from the cake of suspended particulate is obtained.

The invention relates to the sector of plants for the treatment of biological sludges.

In particular, the invention relates to a combined chemical-physical and biological plant for the treatment of sludges deriving from biological purification plants of urban, mixed urban-industrial and industrial waste waters, for example produced by biological purification processes with active sludges, aimed at complete recovery, in the form of Secondary Raw Materials and Energy, of the residual capacities of these sludges.

In more detail, the invention relates to a plant which, in its complete version, constitutes a system architecture that functionally connects single process sections, composed in turn both of conventional and of innovative plants, achieving the aim of producing complete recovery, in the form of secondary raw materials and energy, of the content of biological sludges deriving from aerobic and from anaerobic treatments, but which can also be extended in general to organic liquid wastes and to other types of biomass.

The treatment technique currently most widely used in Italy for the treatment of biological sludges is direct recovery of organic material for agricultural use, for spreading as it is, after separate drying of the sludges, or for composting; instead, other European countries prevalently use energy recovery by combustion in incinerators, i.e. thermal boilers of adequate capacity, after drying of wet sludges produced by purifiers.

These techniques have some limits and disadvantages.

Direct use of biological sludges for agricultural purposes causes problems, as they can only be applied to soils in periods in which no crops are being grown, and it is therefore seasonal, due to the fact that not all soils have suitable agricultural and textural properties, to the problem of protecting the water table and to the possible pollution load still contained in sludges, such as bioaccumulable heavy metals, biopersistent organic molecules, pathogenic agents, etc.

The greatest limits concerning energy recovery from biological sludges are instead related to high moisture content, and consequently low heating capacity—so low as to be unable to support the combustion process alone—to physical condition, which makes management of logistics difficult, as the place of production (community purification plants and the like) does not generally coincide with the place of use (heating plants, incineration plants), and to related environmental problems linked to factors of health and hygiene and secondary pollution from heavy metals in the combustion residues to be disposed of in a suitable and safe manner.

The invention aims to overcome these limits, by producing a plant that can be easily structured with modular sections for partial or complete recovery of the capacities of biological sludges, in terms of substances contained and energy.

The purpose of the plant is firstly to segregate and separate the most dangerous part contained in sludges, constituted by heavy metals, from the more precious protein part, and to destroy pathogenic agents.

The net result, in the complete configuration of the plant, is that of producing a protein lysate susceptible to be used for noble applications; of obtaining Nitrogen fixation in a form that can be reintroduced into the environment, a dispersion of re-usable lime milk, gaseous fuel, electrical and thermal energy, without generating any substances to be disposed of in waste disposal sites or to be sent for incineration.

These aims are achieved with a plant for the treatment of biological sludges with recovery of secondary raw materials and energy comprising:
a feed section of biological sludges;
a feed section of primary and secondary raw materials required for operation of the plant;
   characterized in that it comprises:
a section for the treatment of biological sludges wherein, through a reactor, a process of alkaline protein lysis is performed at medium-low temperature, through dosage of a Calcium or Sodium Hydroxide, obtaining a suspension comprising a protein broth and a suspended body composed of said Calcium or Sodium Hydroxide, of the non-solubilized organic fraction and of the particulate of the hydroxides of the polluting metals contained in said sludges and wherein, through a forced filtration device of said suspension, separation of the liquid protein lysate from the cake of suspended particulate is obtained.

According to an aspect of the invention, in the reactor that performs the process of alkaline protein lysis at medium-low temperature, lime milk or caustic soda is added to the biological sludges to obtain a suspension with pH higher than 12 and the temperature is then taken advantageously to between 40° C. and 90° C., at atmospheric pressure, and mixed for a maturation time generally between 2 and 10 hours depending on the temperature used and on the degree of solubilization of the organic fraction to be obtained.

Advantageously, said filtration device comprises a centrifuge.

According to a more complex embodiment of the plant, the protein lysate broth is treated in a thermophilic aerobic fluidized bed reactor, for completing the purification cycle of the organic load contained in the aqueous phase.

On the basis of a further embodiment of the plant, said protein lysate broth, optionally together with aerobic sludges, with organic liquid wastes and with biomasses, is fed into an anaerobic digester in which the organic Carbon is transformed into biogas, while the residual organic load of the liquid phase delivered from the anaerobic treatment is received by said thermophilic aerobic reactor, which performs reduction thereof with a high output. The digested sludges of the methanation process return to the dedicated line for the lysis process, while the purged sludges of the thermophilic aerobic reactor pass to the centrifugation section for recovery of the hydroxides.

According to an even more complete embodiment of the plant, the Methane delivered from the anaerobic digester, stored in a gas holder, is used as fuel in a Lime recovery kiln, while the combustion smokes of the kiln are sent to a boiler for the production of steam that feeds a condensing turbine for the production of electrical energy to primarily satisfy the electricity needs inside the plant, while the surplus is transferred for sale on the electricity market as product from renewable sources. The condensates feed the internal heat recovery circuit at medium temperature (90° C.) destined to heat the alkaline lysis reactor. The temperature regulation water of the thermophilic aerobic reactor feed the heat recovery circuit at low temperature (45° C.) destined to heat the anaerobic digester.

Preferably, the organic Nitrogen contained in the sludges is partly converted into Ammonia, contained in the flow of treated waters delivered from the thermophilic reactor, which, through stripping and subsequent

Even more preferably, the slaked Lime used in the form of lime milk in the base process of alkaline lysis is recovered through calcination in the kiln of the cake separated by centrifugation of the protein lysate and slaking with treated recycled water. A part is purged to avoid the accumulation of impurities and destined to be re-used externally.

Finally, the excess process waters, not re-used in the plant, are subjected to a completion purification treatment, which can be performed in a conventional active sludge aerobic plant, before their release into the environment.

The invention has numerous advantages: complete recovery of all the inherent capacities in the biological sludge, through the hot lysis process; separation of the most dangerous part contained in the sludges, constituted by heavy metals, so that they can be sent to an authorized waste disposal site for inorganic sludges; destruction of pathogenic agents; production of a broth containing only the protein lysate susceptible to be used for various noble applications, such as re-use for its content in protein bases both in animal nutrition, as a supplement, and in agriculture; Nitrogen fixation and its transformation into Ammonium Sulphate, a form easily reintroduced into the environment, which can be destined both for agriculture and for industry; production of a dispersion of lime milk contaminated by the heavy metals present and separated from the sludges, re-usable in chemical-physical treatment plants of waste waters in substitution of commercial Lime, as the sludges output from these treatments are destined for disposal in waste disposal sites for inorganic sludges; recovery of electrical and thermal energy and of chemical products, without anything to dispose of in waste disposal sites or send for incineration; possible re-use of the process waters both for the preparing/slaking the Lime and for initial dispersion of the biological sludges received to the plant in solid physical state.

The main advantage with respect to current technologies is therefore that of allowing closure of the cycle of residual sludges in the production plant thereof, freeing it from or, if only the minimum version of the invention is used, greatly reducing dependence on outside plants.

A further great advantage is the capacity to integrate, in its modular configuration, all pre-existing equipments in the purification centre, thus achieving evident savings in terms of size of investments required.

Another advantage is that of using technologies homogeneous with those existing in the purification centre, and consequently of finding a suitable management structure and qualified personnel already present.

Finally, a particularly important advantage is that of being able to structure basin plants to achieve the evident economies of scale, choosing within this basin the site that is most structured and requires the fewest investments for the construction and management of the plant, also in its complete configuration, also without requiring other centres in the basin to dry the sludges in order to transfer them, saving on new investments and additional energy management costs and relative environmental impacts.

The advantages of the invention will be more evident hereunder, in the description of a preferred embodiment, provided by way of non-limiting example and with the aid of the figures, wherein:

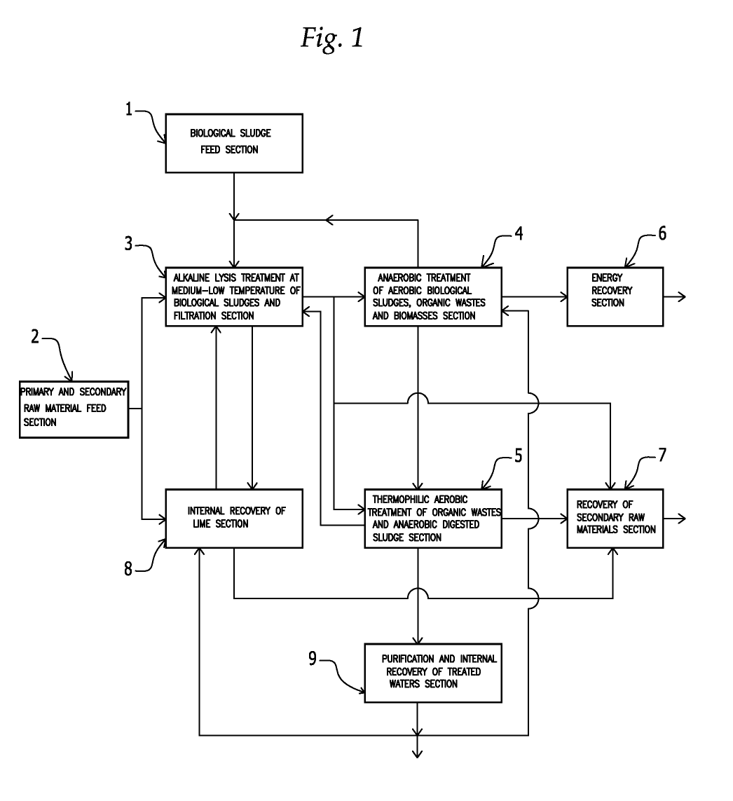

FIG. 1 represents a general block diagram of the sections constituting a plant for the treatment of biological sludges with recovery of secondary raw materials and energy according to the invention;

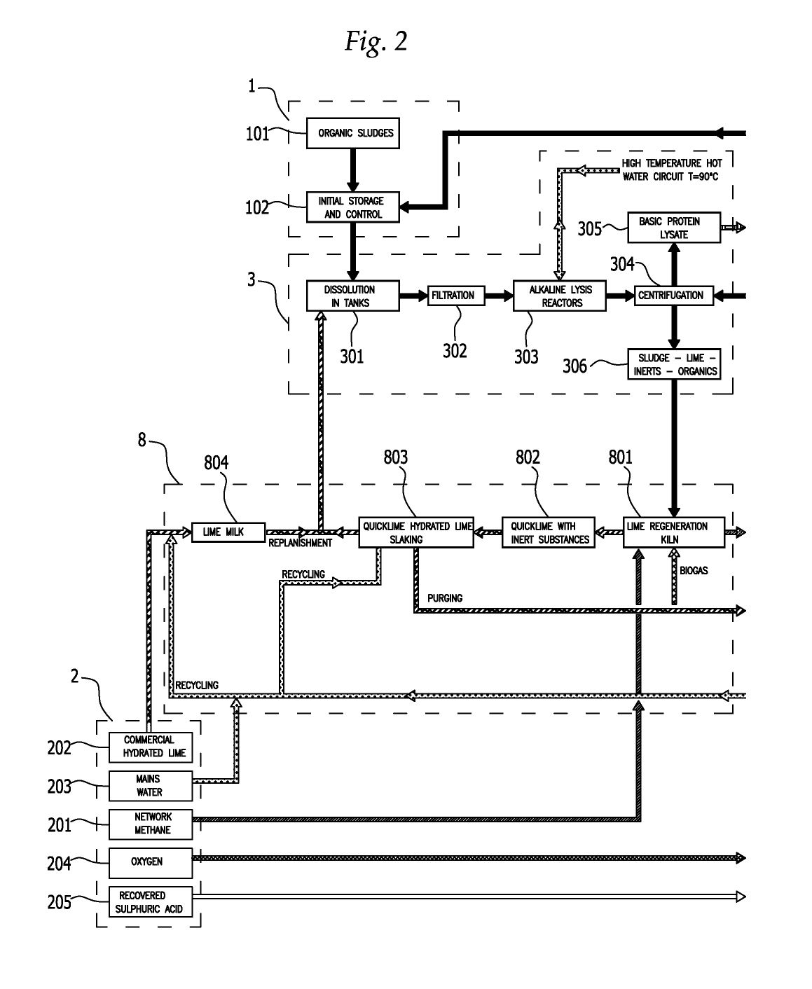

FIGS. 2-4 show in detail the components of the sections and the specific flows of the diagram of FIG. 1.

With reference to FIG. 1, the plant for the treatment of biological sludges with recovery of secondary raw materials and energy, in its complete version, substantially comprises the following functional sections:
a feed section 1 of biological sludges;
a feed section 2 of primary and secondary raw materials required for operation of the plant;
a section 3 for alkaline lysis treatment at medium-low temperature of biological sludges and filtration;
a section 4 for conventional anaerobic treatment of biological sludges produced by aerobic plants, of organic wastes inside and outside the plant and of biomasses;
a section 5 for non-conventional thermophilic aerobic treatment of organic wastes inside and outside the plant and anaerobic digested sludge;
a section 6 for energy recovery;
a section 7 for recovery of secondary raw materials;
a section 8 for recovery of Lime inside the plant;
a section 9 for conventional purification and recovery of treated process waters inside the plant.

With reference to FIGS. 2-4, the plant, in its most complete version, performs integrated recovery of material and energy from biological sludges, through treatment sections identified by broken lines and interconnected to one another through paths identified graphically with diversified backgrounds.

With reference to FIG. 2, the section 1 comprises a division 101 for feeding biological sludges, for example coming from active sludge aerobic purification plants and an initial storage and control volume 102 for said aerobic sludges or for sludges digested through an anaerobic process.

Again with reference to FIG. 2, the section 2 comprises a division for feeding Methane gas 201 coming from the public network, destined for the section 8; a division 202 for feeding Calcium hydroxide Ca(OH)₂, commercially known as hydrated slaked Lime or, alternatively, Sodium hydroxide NaOH, commercially known as caustic Soda, destined for the section 3; a division 203 for feeding mains water destined for the sections 4 and 8; a division 204 for feeding Oxygen O₂ destined for the section 5; a division 205 for feeding sulphuric acid recovered from industrial processes of known type, destined for the section 5.

Again with reference to FIG. 2, the section 3 comprises tanks 301 for dissolution of Lime milk or caustic Soda in the sludges to obtain a pH higher than 12; it also comprises a device 302 for filtration of the conditioned sludges to eliminate coarse solids; at least one reactor 303 for alkaline lysis set at atmospheric pressure, mixed and heated at medium-low temperature, i.e. between 40° C. and 90° C., with hot water and with volumetric dimensions that ensure a hydraulic retention time of the incoming sludges of between 2 and 10 hours depending on the temperature used and on the degree of solubilization of the organic fraction to be obtained; a forced filtration device 304 of the suspension obtained after treatment, constituted by a protein broth and a suspended body constituted by a lime cake, non-solubilized organic fraction and particulate of the hydroxides of the polluting metals contained in the sludges; a volume 305 for management of the basic protein lysate and a volume 306 for management of organic sludge-lime-inert substances.

Said forced filtration device 304 comprises a centrifuge, although it could comprise a belt press or filter press or any other machinery useful for the purpose.

The liquid basic protein lysate can be destined for section 7 for recovery of secondary raw materials, or for section 4 for conventional anaerobic treatment, or for section 5 for non-conventional thermophilic aerobic treatment.

The cake of suspended particulate is sent to the section 8, which performs recovery of lime inside the plant.

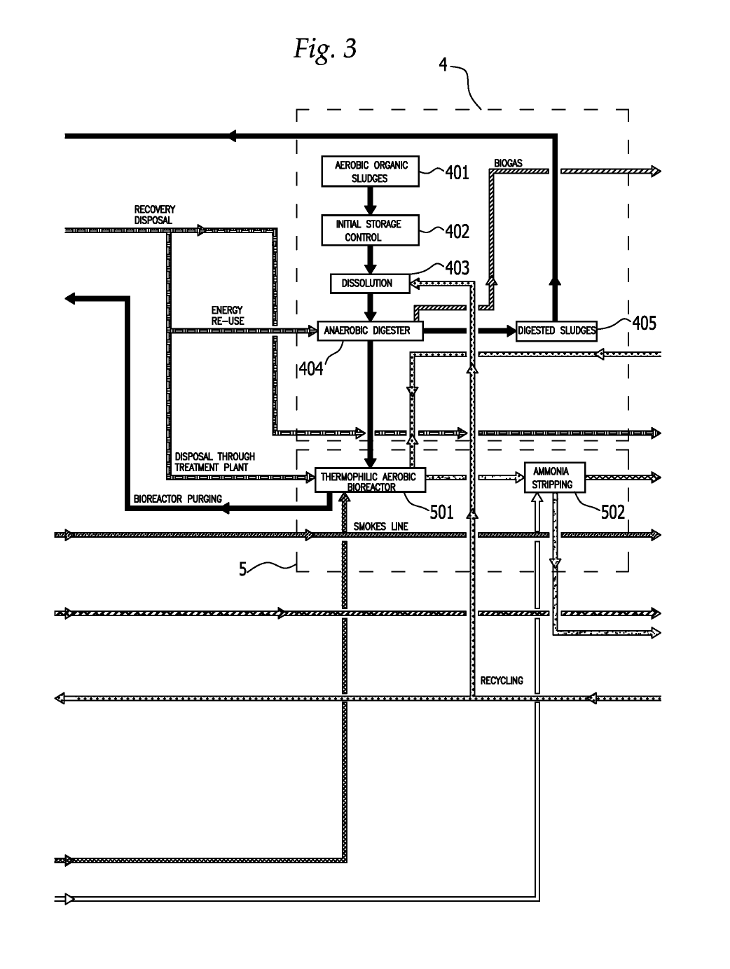

With reference to FIG. 3, section 4 comprises a division 401 for feeding biological sludges delivered from active sludge aerobic purification plants, organic liquid wastes or biomasses; an initial storage and control volume 402 for said substances; a dissolution tank 403 to obtain a mixture between the substances fed with a correct moisture content, through dosage of internal recycled water; an anaerobic digestion division 404 of conventional type fed with said mixture and with said liquid basic protein lysate; a volume 405 for accumulation of the digested sludges after said anaerobic digestion treatment of conventional type, before sending them to the section 1 for feeding biological sludges to the lysis treatment. The biogas containing Methane obtained from gasification of the organic Carbon is sent to the section 6 for energy recovery.

Again with reference to FIG. 3, the section 5 comprises a thermophilic aerobic fluidized bed reactor 501, non-conventional plant, for example of the type described in the patent application Nₒ CR2010A000001 dated 22 Jan. 2010, to continue the purification cycle of the organic load contained in the aqueous phase constituting the basic protein lysate.

Also the residual organic load contained in the aqueous phase delivered from the anaerobic digester 404 is received by the reactor 501, which performs reduction thereof with a high output.

which performs reduction thereof with a high output.

The sections 4 and 5 are therefore mutually connected in series, and in parallel with respect to the section 3.

The purged sludges of the reactor 501 pass to the centrifugation device 304 of the section 3, for recovery of sludge containing lime.

The section 5 also comprises a device 502, which performs stripping and subsequent acid absorption of the Ammonia contained in the treated waters delivered from the reactor 501, produced starting from the organic Nitrogen contained in the sludges, transforming it into Ammonium Sulphate.

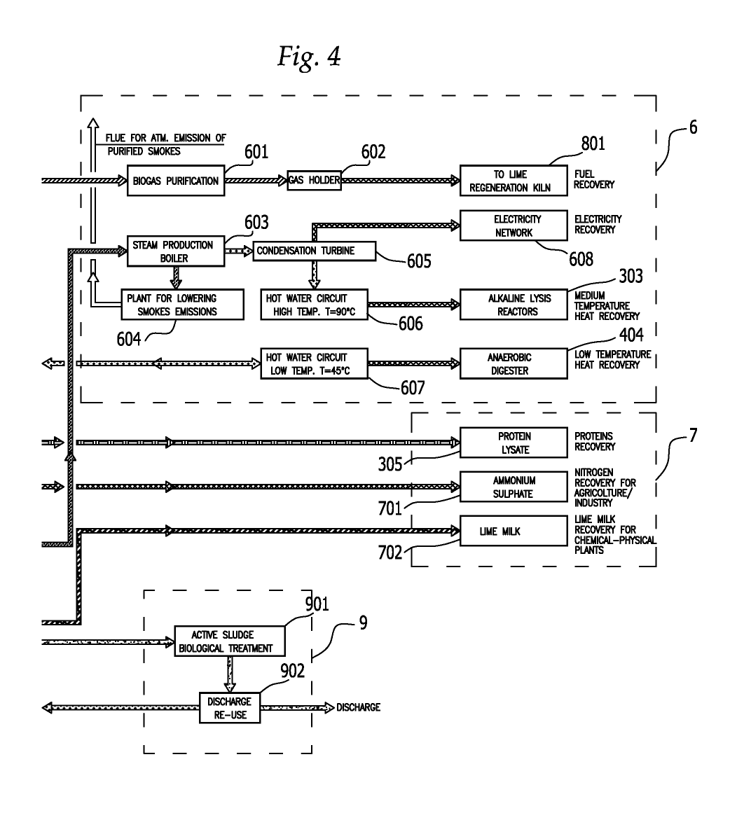

With reference to FIG. 4, the section 6 substantially comprises a biogas purification device 601, a gas holder 602 for storage thereof, a boiler 603 for producing steam, a plant 604 for lowering emissions deriving from smokes, a condensing turbine 605, a high temperature hot water circuit 606 and a low temperature hot water circuit 607.

The gas holder 602 is connected to a calcination kiln 801 present in the section 8 for recovery of lime.

The boiler 603 is fed by the smokes produced in said calcination kiln 801, before these are treated in the plant 604.

The condensing turbine 605 is arranged to produce electrical energy from renewable sources, which primarily supplies the network 608 of utilities inside the whole plant and, optionally and subordinately, the external electricity network and hot water at around 90° C. through the condensate recovery circuit 606. The high temperature hot water is used for the process of alkaline protein lysis.

The low temperature hot water circuit 607 is connected bi-directionally to the thermophilic reactor 501 for heat regulation thereof and is in turn connected to heat the anaerobic digester 404.

Again with reference to FIG. 4, the section 7 substantially comprises a volume 305 for the basic protein lysate susceptible to be re-used both in animal nutrition, as a supplement, and in agriculture; a volume 701 for containing the Ammonium Sulphate destined both for agriculture and for industry; a volume 702 for containing the lime milk deriving from purging of the section 8 which performs recovery of Lime inside the plant, contaminated by the heavy metals separated from the sludges, but re-usable in the chemical-physical treatment plants of waste waters in substitution of commercial Lime, as the sludges output from these treatments are destined for disposal in waste disposal sites for inorganic sludges.

Again with reference to FIG. 2, the section 8 substantially comprises a calcination kiln 801 of the cake of solids separated by centrifugation of the basic protein lysate; a volume 802 for containing Quicklime polluted by inert substances and heavy metals; a reactor 808 for slaking the Quicklime with treated recycled water and producing Calcium Hydroxide, with purging of a part to avoid accumulation of impurities and destined to be re-used externally; a lime milk production device 804.

Again with reference to FIG. 4, the section 9 substantially comprises an active sludge biological treatment 901 of the output waters from the thermophilic reactor 501, after stripping the Ammonia in the reactor 502; and a volume 902 for accumulation of the purified waters re-usable both for preparing/slaking the lime and for initial dispersion of the biological sludges received to the plant in solid physical state.

The architecture of the plant is arranged for being simplified and adapted to the concrete situations of community purification plants for the existing conventional plant equipments, integrating and expanding them.

The minimum plant for an existing civil community plant is that provided with the sections 1, 2, 3 and 5, substantially obtaining its integration with the low temperature lysis reactor 303 and the thermophilic aerobic reactor 501, making use of the particular characteristics of the thermophilic reactor, if appropriately configured, to achieve a very low production of surplus sludge.

Instead of being sent to the separation line existing in the purification plant (centrifugation, filtration), the thickened liquid sludges are subjected to basic lysis and then to thermophilic aerobic digestion, which greatly reduces their quantity, achieving a corresponding saving in the reduction of disposal costs.

In this case, using only the heat recovered by the thermophile, lysis will be conducted at low temperature and, as there is no recovery of lime, it will be less costly and more effective to use Soda in place of Lime.

Other intermediate configurations between the minimum configuration set forth above and the complete configuration illustrated in FIG. 1 are also possible, always starting from the specific plant design situation already existing for each purification site.

1. A plant for the treatment of biological sludges with recovery of secondary raw materials and energy comprising:
a feed section (1) of biological sludges;
a feed section (2) of primary and secondary raw materials required for operation of the plant;
characterized in that it comprises:
a section (3) for the treatment of biological sludges wherein, through a reactor (303), a process of alkaline protein lysis is performed at medium-low temperature, through dosage of a Calcium or Sodium Hydroxide, obtaining a suspension comprising a protein broth and a suspended body composed of said Calcium or Sodium Hydroxide, of the non-solubilized organic fraction and of the particulate of the hydroxides of the polluting metals contained in said sludges and wherein, through a forced filtration device (304) of said suspension, separation of the liquid protein lysate from the cake of suspended particulate is obtained.

2. A plant according to claim 1, characterized in that the reactor (303) that performs the process of alkaline protein lysis at medium-low temperature is set at atmospheric pressure, comprises feed means of lime milk or caustic soda to obtain a suspension with pH higher than 12; heating means to take the temperature to between 40° C. and 90° C.; mixing means for said suspension, and has a volume arranged for ensuring a hydraulic retention time of the incoming sludges of between 2 and 10 hours depending on the temperature used and on the degree of solubilization of the organic fraction to be obtained.

3. A plant according to claim 1, characterized in that said forced filtration device (304) comprises a centrifuge.

4. A plant according to claim 1, characterized in that it comprises a thermophilic aerobic fluidized bed reactor (501), arranged for treating the protein lysate broth and for completing the purification cycle of the organic load contained in the aqueous phase forming the basic protein lysate.

5. A plant according to claim 4, characterized in that it comprises a device (502), arranged for performing stripping and subsequent acid absorption of the Ammonia contained in the treated waters delivered from the reactor (501) produced starting from the organic Nitrogen contained in the sludges, transforming it into Ammonium Sulphate.

6. A plant according to claim 1, characterized in that it comprises an anaerobic digester (404) arranged for treating at least said protein lysate broth and for transforming the organic Carbon into biogas, and arranged for supplying the residual organic load contained in the liquid phase delivered from the digester to said thermophilic aerobic reactor (501).

7. A plant according to claim 1, characterized in that it comprises a biogas purification device (601); a gas holder (602) for storage thereof; a boiler (603) for producing steam; a plant (604) for lowering combustion gas emissions; a condensing turbine (605); a high temperature hot water circuit (606) and a low temperature hot water circuit (607).

8. A plant according to claim 1, characterized in that it comprises a volume (305) for the basic protein lysate susceptible to be re-used both in animal nutrition, as a supplement, and in agriculture; a volume (701) for containing the Ammonium Sulphate destined both for agriculture and for industry; a volume (702) for containing the lime milk deriving from purging of a circuit for recovery of Lime inside the plant.

9. A plant according to claim 1, characterized in that it comprises a calcination kiln (801) of the cake of solids separated by centrifugation of the basic protein lysate; a volume (802) for containing Quicklime polluted by inert substances and heavy metals obtained in the kiln (801); a reactor (808) for slaking the Quicklime with treated recycled water and producing Calcium Hydroxide, with purging of a part to avoid accumulation of impurities and destined to be reused externally; a lime milk production device (804).

10. A plant according to claim 1, characterized in that it comprises an active sludge biological treatment (901) of the output waters from the thermophilic aerobic reactor (501), after stripping the Ammonia in the device (502); and a volume (902) for accumulation of the purified waters reusable both for preparing/slaking the lime and for initial dispersion of the biological sludges received to the plant in solid physical state.
